(19) United States
(12) Patent Application Publication
(10) Pub. No.: US 2015/0253917 A1
(43) Pub. Date: Sep. 10, 2015

(54) TOUCH PANEL, DISPLAY PANEL, AND STRENGTHENED STRUCTURE FOR PROTECTIVE SUBSTRATE

(71) Applicant: Innolux Corporation, Miao-Li County (TW)

(72) Inventors: Chia-Fu FAN, Miao-Li County (TW); Tsu-Hsien KU, Miao-Li County (TW); Chia-Rung HSU, Miao-Li County (TW); Jing-Jia YEH, Miao-Li County (TW)

(21) Appl. No.: 14/638,218

(22) Filed: Mar. 4, 2015

(30) Foreign Application Priority Data
Mar. 7, 2014 (TW) 103107859

(51) Int. Cl. G06F 3/041; G06F 1/16

(52) U.S. Cl. CPC G06F 3/0412; G06F 1/16; G06F 2203/04107

(57) ABSTRACT

The present invention relates to a touch panel, a display panel, and a strengthened structure for a protective substrate, wherein the touch panel comprises: a touch sensing layer; a buffer layer disposed over the touch sensing layer and having a first surface and a second surface, wherein the second surface faces towards the touch sensing layer; and a protective substrate disposed on the first surface of the buffer layer.

### CROSS REFERENCE TO RELATED APPLICATION

This application claims the benefits of the Taiwan Patent Application Serial Number 103107859, filed on Mar. 7, 2014, the subject matter of which is incorporated herein by reference.

### BACKGROUND OF THE INVENTION

1. Field of the Invention

The present invention relates to a touch panel, a display panel, and strengthened structure for a protective substrate, and especially to a One-Glass-Solution (OGS) touch panel.

2. Description of Related Art

In recent years, with the rapid development of portable electronic products, especially the constantly change of the portable electronic products with a display or touch panel, consumers have more and more severe requirements for portable electronic products. For improved portability, various types of display panels and touch panels are developed toward light weight and minimization, and when the display panels or touch panels are impacted under pressure or dropped down, the minimized protective glass is easy to crack and damaged.

To reinforce the protective glass of the display panel or touch panel, the ion exchange method, for example, is conventionally used to form a chemical-strengthened glass. Alternatively, a protective layer is formed at the cut edge of the protective glass, to prevent the entire protective glass from breakage due to tiny cracks at the edge. However, the strengthened protective glass prepared by conventional methods is still prone to rupture upon a greater impact force. In addition, when an external force hits the protective glass on the operation surface of the touch panel, the breakage of the protective glass, if any, is usually generated from the surface of the touch sensing layer.

To solve the above problem, what is needed is a novel strengthened structure for protective layers, to provide a touch panel or a display panel with more excellent mechanical properties.

### SUMMARY OF THE INVENTION

An object of the present invention is to provide a touch panel, wherein a buffer layer is disposed on one side of a protective substrate to provide the protective substrate with impact resistance and improved mechanical properties.

To achieve the above object, the touch panel of the present invention comprises: a touch sensing layer; a buffer layer disposed over the touch sensing layer and having a first surface and a second surface, wherein the second surface faces towards the touch sensing layer; and a protective substrate disposed on the first surface of the buffer layer,

In the touch panel of the present invention, the touch sensing layer further comprises: a plurality of first direction electrodes, a plurality of second direction electrodes and an insulating layer.

In the touch panel of the present invention, the material of the buffer layer comprises at least one selected from the group consisting of polysiloxane, modified polysiloxane, and a mixture thereof. The buffer layer has the following characteristics: a light transmittance of 90% to 99.9% and preferably 92% to 99.9%; a haze value of 0.01% to 0.5% and preferably 0.01% to 0.3%; the second surface having an average roughness of 0.1 to 3 nm and preferably 0.1 to 2.4 nm; a CIE LAB color difference ΔE of 0.1-1 after a heat treatment at 300° C.; and a weight loss of less than or equal to 5% after a heat treatment at 300° C.

In an example of the present invention, the buffer layer comprises a polymer represented by Formula I below:

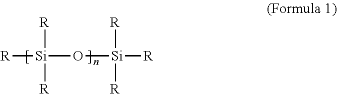

wherein each R is the same or different, and selected from the group consisting of hydrogen, a substituted or unsubstituted C1-10 alkyl group, a substituted or unsubstituted C2-10 alkenyl group, a substituted or unsubstituted C6-15 aryl group, and a substituted or unsubstituted C1-10 alkoxy group, and n is a positive integer.

Another object of the present invention is to provide a display panel, comprising: a display element; a buffer layer disposed over the display element and having a first surface and a second surface, wherein the first surface faces towards the display element; and a protective substrate disposed on the second surface of the buffer layer,

A further object of the present invention is to provide a strengthened structure for a protective substrate, comprising: a protective substrate; a buffer layer disposed over the protective substrate.

### BRIEF DESCRIPTION OF THE DRAWINGS

FIGS. 1 to 2 show schematic diagrams showing a process for manufacturing the touch panel according to Example 1 of the present invention.

FIG. 3 shows a cross-sectional view of the structure of the touch panel according to the present invention.

FIG. 4a shows a schematic diagram of the capacitive touch electrode layer according to the present invention.

FIG. 4b shows a cross-sectional view along the line A-A′ in FIG. 4a.

FIG. 5 shows a cross-sectional view of the structure of the touch panel according to Example 2 of the present invention.

FIG. 6 shows a cross-sectional view of the strengthened structure for a protective substrate according to Example 3 of the present invention.

FIG. 7 shows a cross-sectional view of the structure of the touch panel according to Comparative Example 1 of the present invention.

FIG. 8 show a schematic diagram of the test method according to Test Example 1 of the present invention.

### DETAILED DESCRIPTION OF THE PREFERRED EMBODIMENT

Hereinafter, exemplary examples of the present invention will be described in detail. However, the present invention is not limited to the examples disclosed below, but can be implemented in various forms. The following examples are described in order to enable those of ordinary skill in the art to embody and practice the present invention, and those skilled in the art will appreciate that various modifications, additions and substitutions are possible.

### Example 1

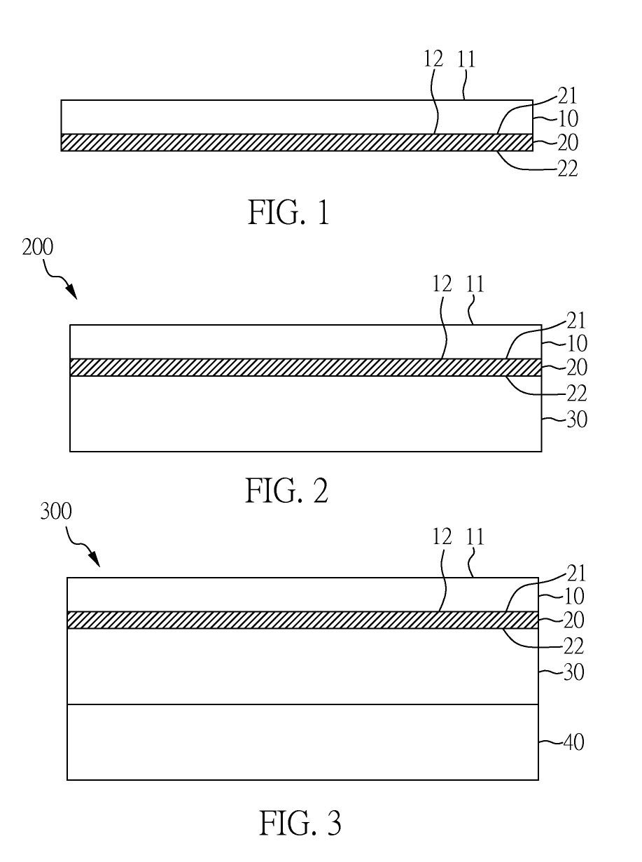

Referring to FIG. 1, a buffer layer 20 is formed on a lower surface 12 of a protective substrate 10, wherein a first surface 21 of the buffer layer 20 is in contact with the protective substrate 10. Then, as shown in FIG. 2, a touch sensing layer 30 is provided on a second surface 22 of the buffer layer 20 and in contact with the touch sensing layer 30. The obtained touch panel 200 comprises a touch sensing layer 30; the buffer layer 20 disposed over the touch sensing layer 30 and having a first surface 21 and a second surface 22, wherein the second surface 22 faces towards the touch sensing layer 30; and the protective substrate 10 disposed on the first surface 21 of the buffer layer 20.

In this example, the protective substrate 10 is made of a transparent glass or a flexible substrate, and an upper surface 11 of the protective substrate 10 is used as the operation surface of the touch panel, which is also the surface that receives external impact. For example, the protective substrate 10 may be a poly(methacrylate) (acrylic resin) substrate, a heat strengthened glass, a chemically strengthened glass, a laminated glass and so on.

In this example, the buffer layer 20 is made of polysiloxane having a thickness of 10-100 μm, and the material of the buffer layer 20 may comprise a polymer represented by Formula 1 below:

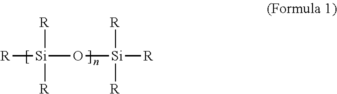

wherein each R may be the same or different, and selected from the group consisting of hydrogen, a substituted or unsubstituted C1-10 alkyl group, a substituted or unsubstituted C2-10 alkenyl group, a substituted or unsubstituted C6-15 aryl group, and a substituted or unsubstituted C1-10 alkoxy group, and n is a positive integer. R is preferably selected from the group consisting of a substituted or unsubstituted C1-6 alkyl group, a substituted or unsubstituted C2-6 alkenyl group, a substituted or unsubstituted C6-12 aryl group, and a substituted or unsubstituted C1-6 alkoxy group. Specifically, the polymer represented by Formula 1 may be poly(dimethylsiloxane) and so on.

Further, the touch panel of the present example may additionally comprise a display element 40, as shown in FIG. 3. The display element 40 is disposed under the touch sensing layer 30, to form a touch display panel 300. To avoid detrimental influence on the performance of the display panel, the buffer layer 20 disposed between the protective substrate 10 and the touch panel 40 needs to have excellent optical properties, and the buffer layer 20 has a light transmittance of 92% as measured by a spectrometer, Cary 300 and a haze value of 0.3% as measured by a haze meter, BYK-Gardner-4725. In addition, the first surface and the second surface respectively has an average roughness of 2.4 nm. However, in other embodiments, the buffer layer may have a light transmittance of 90% to 99.9%, preferably 92% to 99.9%; a haze value of 0.01% to 0.5%, preferably 0.01% to 0.3%; and the first surface and/or the second surface may have an average roughness of 0.1 to 3 nm, preferably 0.1 to 2.4 nm. Further, the buffer layer 20 will be subjected to subsequent panel processes after forming on the protective substrate 10, so the buffer layer 20 may have a slight weight loss and color difference during a high temperature process. Furthermore, the buffer layer 20 should maintain its thermal stability in the subsequent processes, and therefore the buffer layer 20 of the present invention should meet certain qualitative requirements. The weight loss of the buffer layer 20 upon heating to 300° C. may be less than or equal to 5% as measured using a thermogravimetric analyzer (TGA). In addition, the CIE LAB color difference ΔE of the buffer layer 20 on heating to 300° C. can be 0.1 to 1 as measured using Konika Minolta/CM-3600d. The color difference is obtained by conversion of the visible light to a CIE LAB color space, which is well known to the skilled person in the art, and the detail is not repeated here.

In addition, the buffer layer 20 of this example has excellent heat resistance, and can exhibit excellent thermal stability in the subsequent processes of the touch panel, and therefore its glass transition temperature is not less than 300° C.

Further, in the example, the buffer layer 20 also has excellent chemical resistance and water-boiling resistance, such that the buffer layer 20 is against corrosion in 10 w/w % of acid or base for 30 minutes, and resistant to boiling water at 100° C. for 60 minutes.

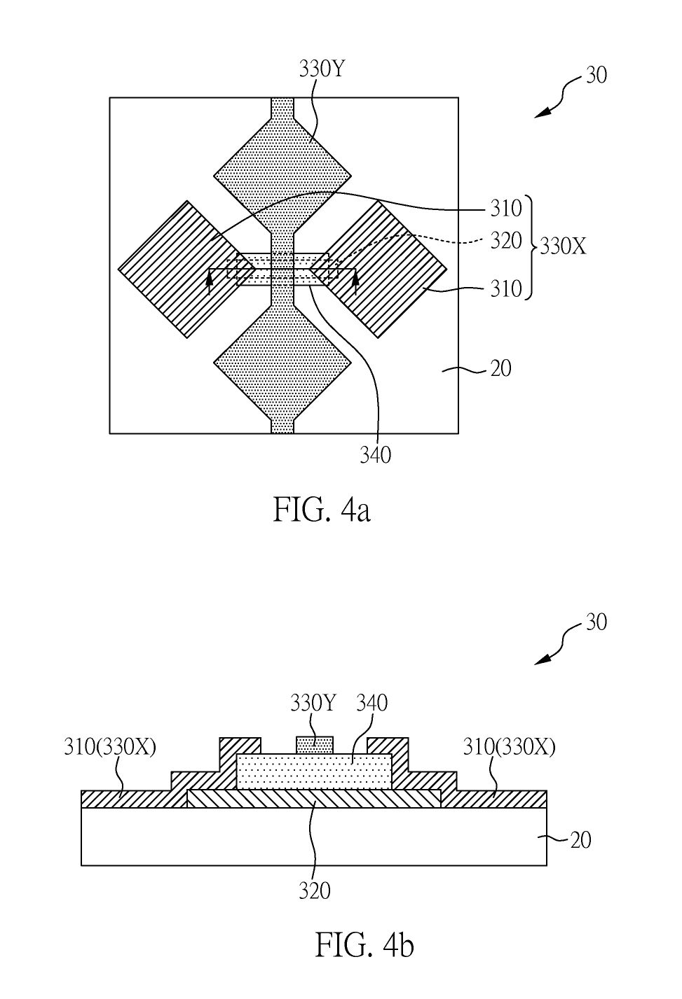

Furthermore, the touch sensing layer 30 of this example may be, but not limited to, a resistive sensing electrode layer, a capacitive sensing electrode layer, an optical sensing layer, an acoustic touch sensing layer, an infrared touch sensing layer touch sensing layer, and other forms of touch sensing layers depending on practical applications. The capacitive touch sensing electrode layer is used for illustrative purpose in this example. FIGS. 4a and 4b show the schematic diagram of the capacitive touch electrode layer, wherein FIG. 4b is a cross-sectional view along the line A-A′ in FIG. 4a. As shown in FIGS. 4a and 4b, a plurality of first direction electrodes 330X and a plurality of second direction electrodes 330Y are disposed on the buffer layer 20 for touch sensing, and extend in different directions respectively. The first direction electrodes 330X may comprise two adjacent touch electrode pads 310 which are electrically connected via a bridge portion 320. That is, the bridge portion 320 may be firstly formed on the buffer layer 20, and then an insulating layer 340 is formed on the bridge portion 320, with a portion of the bridge portion 320 being exposed. In addition, the touch electrode pads 310 of the first direction electrode 330X and the second direction electrode 330Y can be formed simultaneously, so that the touch electrode pads 310 may be in contact with and electrically connected to the bridge portion 320 exposed from the insulating layer 340.

Furthermore, in other examples, an adhesives and/or a photoresist layer, etc. may be further included between the protective substrate 10, the buffer layer 20, the touch sensing layer 30 and the display element 40. The structures and forming methods of these layers are well known in the art. For example, an adhesive layer may be disposed between the touch sensing layer 30 and the display elements 40 to increase its adhesion strength, or a photoresist layer may be disposed between the touch sensing layer 30 and the buffer layer 20 to shield the exposed metal wiring on the sensing layer 30.

The touch panel of the present invention is applicable to any device which needs a transparent touch panel, for example: a vehicle display, a touch panel, an electromagnetic isolation glass, a cell phone, a solar cell, a portable liquid crystal video game, an LCD panel of a home appliance, a display of an instrument, an organic light-emitting diode display, an liquid crystal display, a notebook computer, a liquid crystal television, a plasma display, an electrode of a color filter, combinations thereof, and so on, and is not particularly limited.

In the present specification, the term “alkyl group” refers to a monovalent straight or branched saturated hydrocarbon having 1 to 10 carbon atoms, and preferably 1 to 6 carbon atoms. The alkyl group may be optionally substituted by at least one substituent. Examples of the alkyl group may comprise methyl, ethyl, propyl, 2-propyl, n-butyl, isobutyl, tert-butyl, pentyl, hexyl and the like.

In the present specification, the term “alkoxy group” refers to a functional group in which the above alkyl group having at least one hydrogen atom substituted by an oxygen atom, and the alkoxy group may optionally be substituted by at least one substituent. Examples of the alkoxy group may comprise methoxy, ethoxy, propoxy, butoxy, pentoxy, and the like.

In the present specification, the term “alkenyl group” refers to a monovalent straight or branched hydrocarbon having 2 to 10 carbon atoms, and preferably 2 to 6 carbon atoms, and having at least one carbon-carbon double bond. The alkenyl group may be optionally substituted by at least one substituent. Examples of the alkenyl group may comprise vinyl, 1-propenyl, 2-propenyl, 2-butenyl, 3-butenyl, pentenyl, and the like.

In the present specification, the term “aryl group” refers to a monocyclic, bicyclic, or tricyclic aromatic hydrocarbon having 6 to 15 cyclic carbon atoms, and preferably 6 to 12 cyclic carbon atoms. The aryl group may be optionally substituted by at least one substituent, and examples of the aryl group may comprise phenyl, naphthyl, fluorenyl and the like.

### Example 2

The preparation procedure and materials used in this Example are substantially the same as in Example 1, and therefore the descriptions in Example 1 are also applicable to the counterparts herein, and the same description will not be repeated.

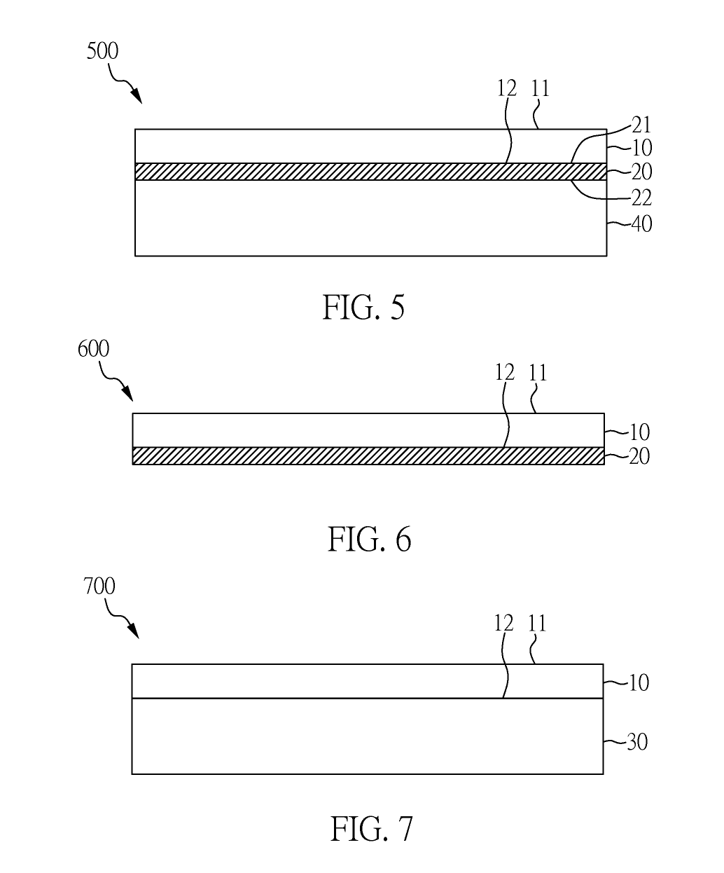

The present example provides a display panel. Referring to FIG. 5, the formed display panel 500 comprises a display element 40; a buffer layer 20 disposed over the display element 40 and having a first surface 21 and a second surface 22, wherein the second surface 22 faces towards the display element 40; and the protective substrate 10 is disposed on the first surface 21 of the buffer layer 20.

The display panel 500 of this example is a liquid crystal display panel, while in other examples, the display panel 500 may be a plasma display panel, an organic electroluminescence display panel, a field emission display panel, and electrophoretic display panel, or a light-emitting diode display panel. The display panel 500 may further comprise various active components or passive components of a display panel typically used in the art, such as a thin film transistor device, a color filter, an organic light-emitting diode unit and a black matrix. Since the various components and structures of the display element will be understood by those skilled in the art, they will not be repeated.

### Example 3

The preparation procedure and materials used in this Example are substantially the same as in Example 1, and therefore the descriptions in Example 1 are also applicable to the counterparts herein, and the same description will not be repeated.

The present example provides a strengthened structure for a protective substrate, as shown in FIG. 6, and the strengthened structure 600 includes a protective substrate 10, and a buffer layer 20 formed on the lower surface 12 of the protective substrate 10.

The strengthened structure 600 for a protective substrate of this example can be applied to a variety of electronic products to protect the surface structure, and for example, in addition to a display panel or a touch panel, it also can be applied to a fingerprint reader, a solar battery or other products, to provide excellent protection.

### Comparative Example 1

The preparation procedure and materials used in this Comparative Example are substantially the same as in Example 1, and therefore the descriptions in Example 1 are also applicable to the counterparts herein, and the same description will not be repeated.

This Comparative Example provides a touch panel including a sensor layer 30; and a protective substrate 10 formed on the sensor layer 30. The formed ouch panel 700 is shown in FIG. 7. In this Comparative Example, the protective substrate 10 is made of a transparent glass.

### Test Example 1

This Test Example is provided to test the impact resistance of the touch panels prepared by the Example 1 and Comparative Example 1 by a falling-ball impact test.

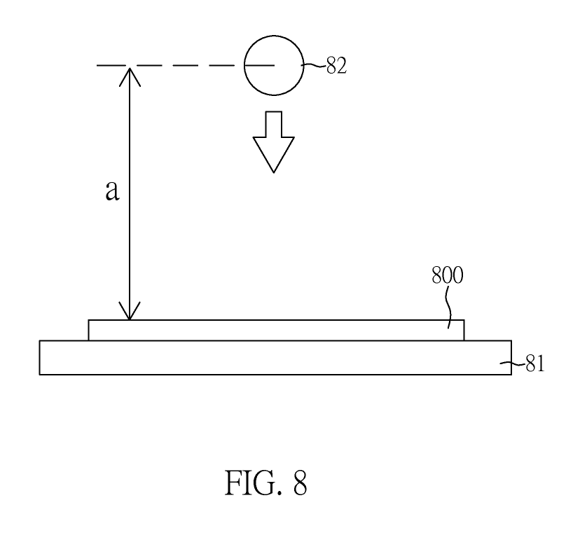

First, as shown in FIG. 8, the touch panels 800 of Example 1 and Comparative Example 1 were respectively placed on the detecting table 81 with the protective substrate facing up, and then an iron ball 82 of 130 g was dropped onto the touch panel 800 from the height a, wherein the height a was constantly adjusted during the test, until the protective substrate of the touch panel 800 was ruptured. The energy for rupturing the touch panel 800 is calculated based on the potential energy of the iron ball 82, and the test results are summarized in Table 1 below.

TABLE 1

| | Height a of iron ball (cm) | Energy for rupture (J) |
|---|---|---|
| Example 1 | 105 cm | 1.338 |
| Comparative | 37 cm | 0.478 |
| Example 1 | | |

The Test Example indicates that the touch panel provided by the present invention has an improved impact resistance for the protective substrate 10 by forming the buffer layer 20 on the surface thereof, and the energy for rupturing the products is increased by 3 times, thus greatly enhancing the mechanical strength of the overall touch panel.

While the invention has been shown and described with reference to certain exemplary examples thereof, it will be understood by those skilled in the art that various changes in form and details may be made therein without departing from the scope of the invention as defined by the appended claims.

What is claimed is:

1. A touch panel, comprising:
a touch sensing layer;
a buffer layer disposed above the touch sensing layer and having a first surface and a second surface, wherein the second surface faces towards the touch sensing layer; and
a protective substrate disposed on the first surface of the buffer layer,
wherein the buffer layer comprises at least a material selected from the group consisting of polysiloxane, modified polysiloxane, and a mixture thereof.

2. The touch panel of claim 1, wherein the buffer layer has a light transmittance of 90% to 99.9%.

3. The touch panel of claim 1, wherein the buffer layer has a haze value of 0.01% to 0.5%.

4. The touch panel of claim 1, wherein the buffer layer has a CIE LAB color difference ΔE of 0.1-1 after a heat treatment.

5. The touch panel of claim 1, wherein the buffer layer has a weight loss of less than or equal to 5% after a heat treatment.

6. The touch panel of claim 1, wherein the first surface or the second surface of the buffer layer has an average roughness of 0.1 to 3 nm.

7. The touch panel of claim 1, wherein the buffer layer comprises a polymer represented by Formula 1 below: 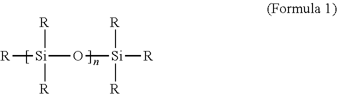
wherein each R is the same or different, and selected from the group consisting of hydrogen, a substituted or unsubstituted C1-10 alkyl group, a substituted or unsubstituted C2-10 alkenyl group, a substituted or unsubstituted C6-15 aryl group, and a substituted or unsubstituted C1-10 alkoxy group, and n is a positive integer.

8. The touch panel of claim 1, wherein the touch sensing layer further comprises: a plurality of first direction electrodes, a plurality of second direction electrodes and an insulating layer.

9. A display panel, comprising:
a display element;
a buffer layer disposed above the display element and having a first surface and a second surface, wherein the second surface faces towards the display element; and
a protective substrate disposed on the first surface of the buffer layer,
wherein the buffer layer comprises at least a material selected from the group consisting of polysiloxane, modified polysiloxane, and a mixture thereof.

10. A strengthened structure for a protective substrate, comprising:
a protective substrate;
a buffer layer disposed on the protective substrate,
wherein the buffer layer comprises at least one material selected from the group consisting of polysiloxane, modified polysiloxane, and a mixture thereof.
